(19) United States
(12) Patent Application Publication
(10) Pub. No.: US 2005/0219121 A1
(43) Pub. Date: Oct. 6, 2005

(54) Smart antenna system with switched beams

(76) Inventor: Po-Chao Chen, Taipei (TW)

Correspondence Address: HARNESS, DICKEY & PIERCE, P.L.C., P.O. BOX 8910, RESTON, VA, 20195, US

(21) Appl. No.: 11/094,437

(22) Filed: Mar. 31, 2005

(30) Foreign Application Priority Data
Apr. 1, 2004 (TW) 93204972

(51) Int. Cl. H01Q 3/02

(52) U.S. Cl. 342/374

(57) ABSTRACT

An antenna with switched beams includes a plurality of antenna units to form several beams, i.e. several sectors of radiation fields, to cover a specific service area using particular beams. All the antenna units can be turned on at the same time to form an omni-directional radiation field, covering all directions around the antenna. The antenna also includes a switching unit to output a switching signal according to the strength of the received signal to switch the orientations of the antenna units and beam widths, in order to achieve an optimal effect.

### BACKGROUND OF THE INVENTION

1. Field of Invention

The invention relates to an antenna and, in particular, to a smart antenna used in the base station of a wireless communication system to automatically adjust the emission angle and switch the beam field.

2. Related Art

The base station is the first level of cell phone systems in direct contact with users. It simultaneously emit, receive radio waves to link with users. Therefore, it is closely related to the signal strength and quality of the user's cell phone. The position of the base station and the angle, orientation, and frequency of the antenna thus determine the service quality of the cell phone system.

In the past few years, countries advanced in the mobile communications industry are devoted to researches and developments in smart base station antennas. Basically, the smart antenna technology in the world has four categories. The first relates to switched beams/fixed beams. A best beam is selected in the fixed narrow beam for transmissions and receptions. It is practically feasible. The second is adaptive beam forming, which is characterized in the feature that the width and orientation of the beam are adaptive. This is particular for CDMA. The first type is interference cancellation. It employs overall adaptive processing to eliminate interference and can be updated at high speeds. The fourth is dynamic sectorization, which dynamically changes the beam width, orientation, and shape in sectorizations to achieve the objects of averaging service loads, managing service alternation, and controlling interference.

Currently, normal antennas can emit within only a certain angles. Therefore, it is desirable to provide an antenna that can automatically adjust its emission range according to the communication loads.

### SUMMARY OF THE INVENTION

In view of the foregoing, an object of the invention is to provide a smart antenna that can automatically adjust its emission angle and switch its beam field. The reception angle can be adjusted according to different communication loads, achieving smart wireless signal reception.

To achieve the above and other objects, the disclosed smart antenna with switched beams has: a set of radiation direction dividing units comprised of a plurality of metal reflector plates that divide space into several radiation directions; a plurality of antenna unit, each of which is correspondingly installed in each of the radiation directions in order to form a specific beam to cover a specific service area (called the sector mode), where all the antenna units can be turned on at the same time to form an omni-directional radiation field to cover all directions around the antenna (called the omni mode); and a switching circuit, which selects and switches to a most appropriate antenna mode according to a received signal in order to achieve most effective antenna uses. The switching circuit has a plurality of switches corresponding to the antenna units. When the smart antenna with switched beams operates in the sector mode, the switching circuit transmits a radio frequency (RF) signal to a corresponding antenna unit. The antenna unit thus radiates the RF signal. When the smart antenna with switched beams operates in the omni mode, the switching circuit transmits an RF signal to all of the antenna units for them to radiate the RF signal.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the structure of the disclosed smart antenna;

FIGS. 2 to 6 are schematic views of the range covered by the disclosed smart antenna;

FIGS. 7 to 11 are schematic circuit diagrams of the switching unit in the disclosed smart antenna;

FIG. 12 is a schematic view of the structure of the antenna unit in the disclosed smart antenna;

FIGS. 13 to 17 show the field shapes in the range covered by the disclosed smart antenna; and

FIG. 18 is a second embodiment of the disclosed smart antenna.

### DETAILED DESCRIPTION OF THE INVENTION

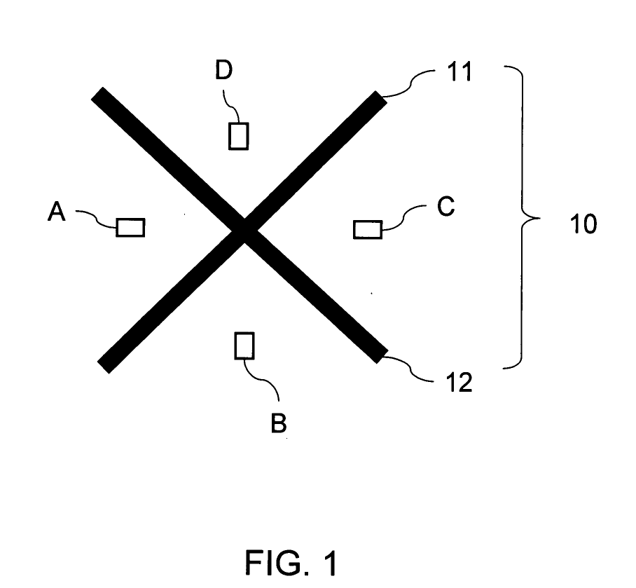

FIG. 1 shows the structure of a smart antenna that automatically adjusts its emission angle and switches beam fields according to the invention. It is used in transceiving radio signals for base stations.

As shown in FIG. 1, the module with four sector antenna beams has four sector structures pointing in different directions. A radiation direction dividing unit 10 composed of a set of metal reflector plates 11, 12 is provided in the middle. Each sector differs from its adjacent ones by 90 degrees. Each sector structure contains its own antenna unit A, antenna unit B, antenna unit C, and antenna unit D.

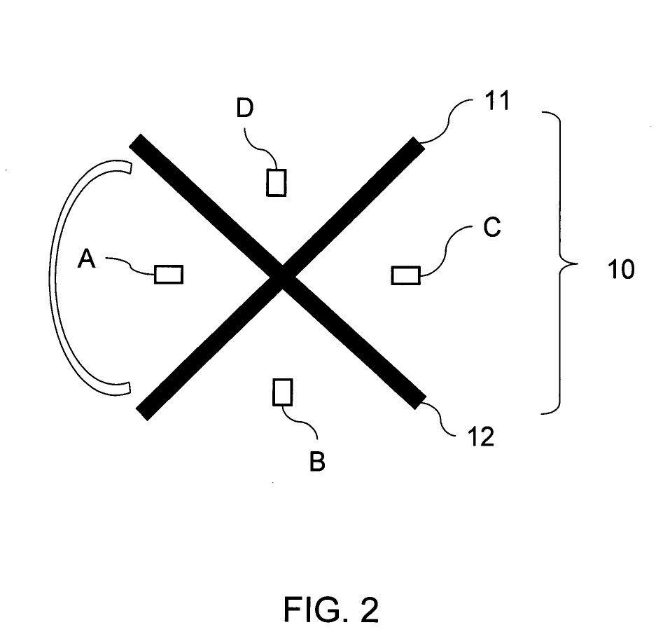

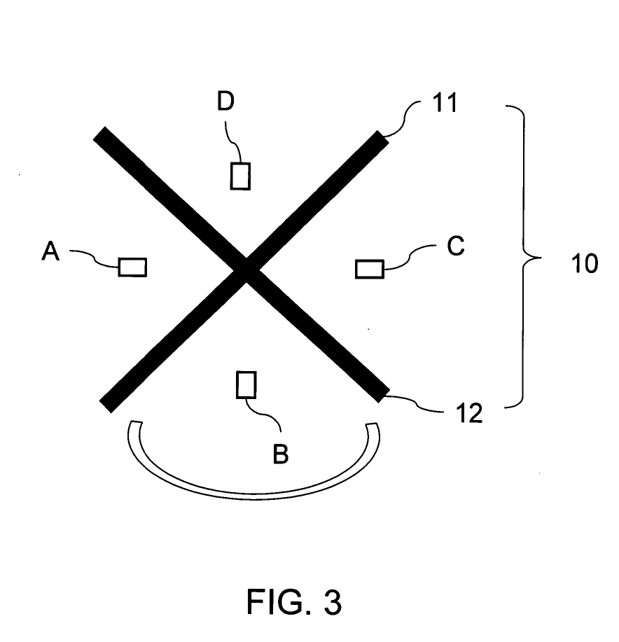

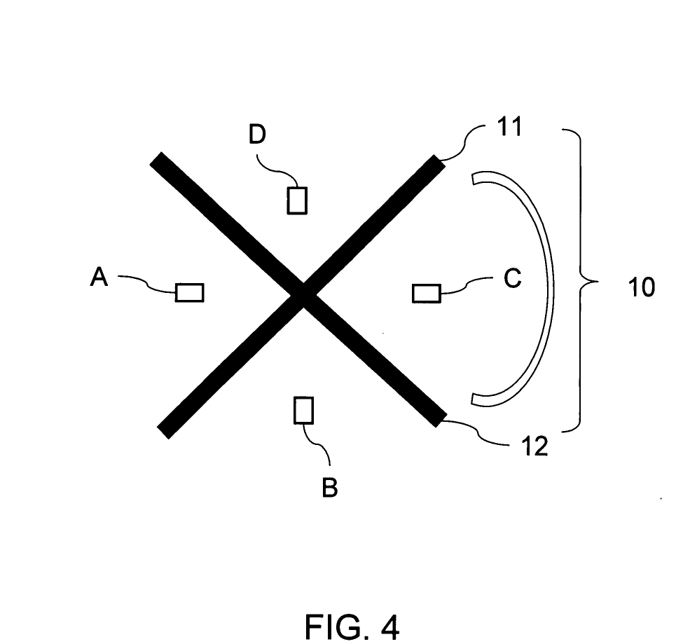

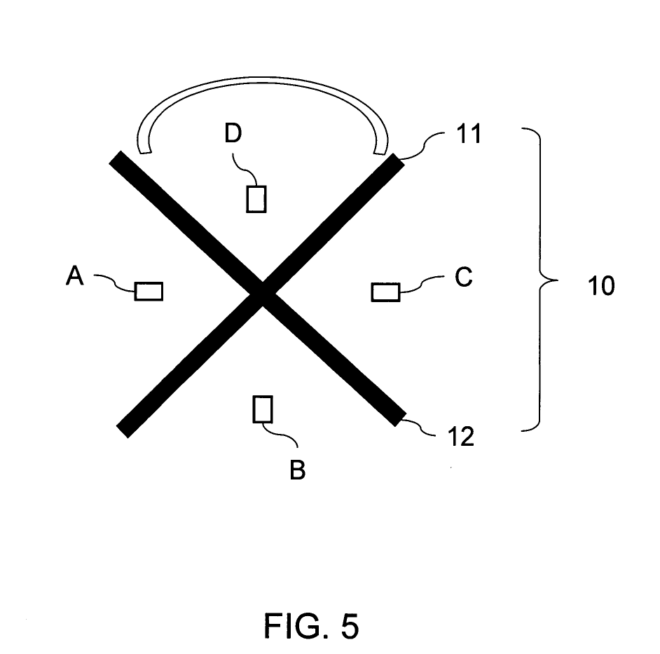

The antenna structure in FIG. 1 has two operating modes, the sector mode and the omni mode. In the sector mode, as shown in FIG. 2, the antenna unit A is turned on and all other antenna units are turned off, thus achieving radiation in a single direction. In this case, the range covered by the smart antenna is determined by that of the antenna unit A. Likewise, as shown in FIGS. 3 to 5, each of the antenna units covers one range of 90 degrees when operating in the sector mode of the antenna units B, C, and D, respectively.

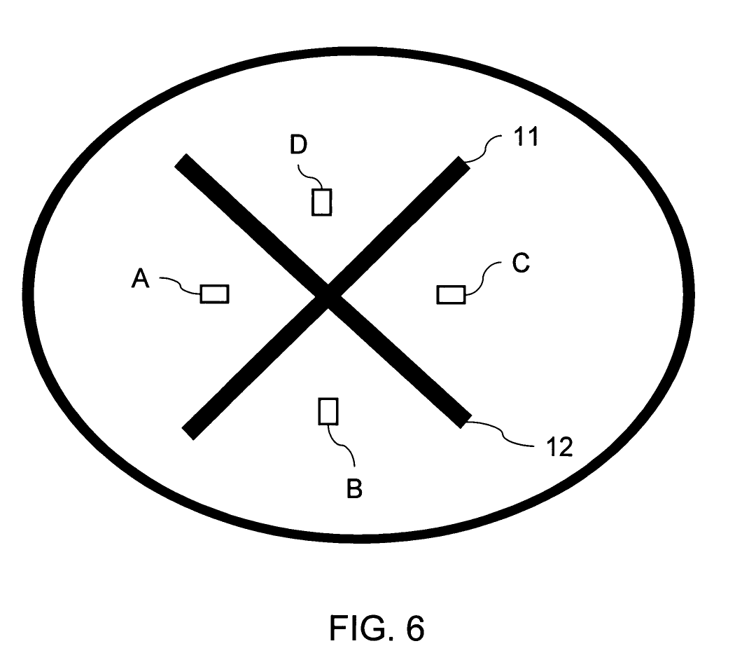

If one wants to use this smart antenna to cover 360 degrees around it, the omni mode is used, as shown in FIG. 6. The antenna units A, B, C, D are turned on simultaneously, making the overall radiation field of the antenna omni-directional and covering the whole 360 degrees around it.

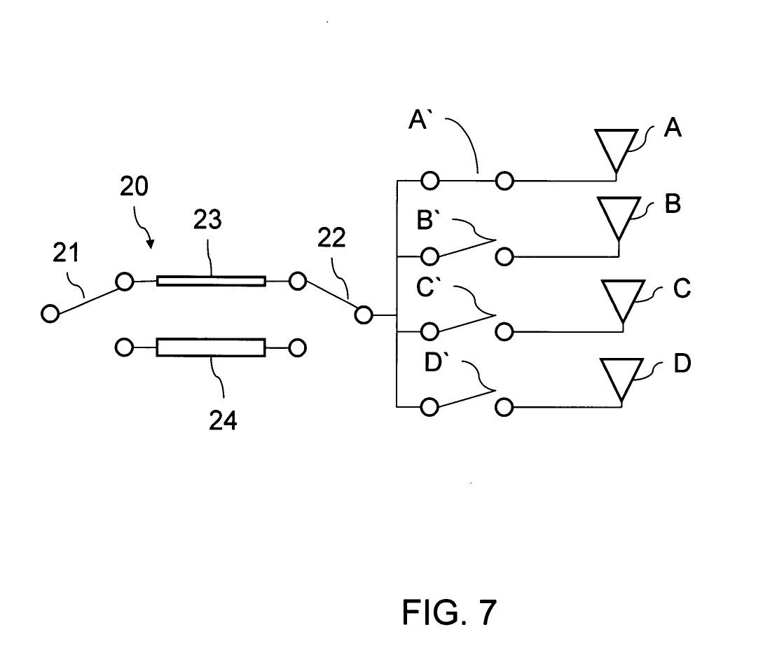

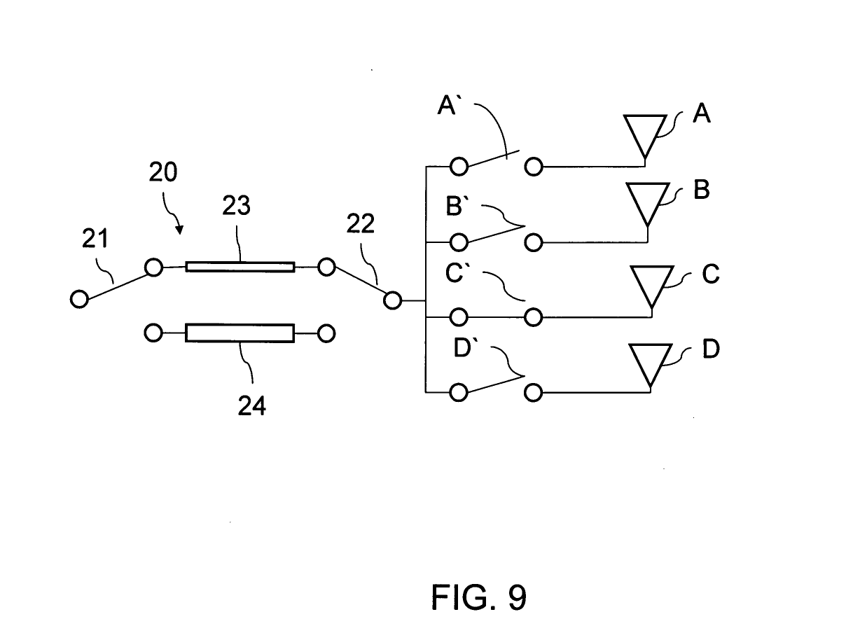

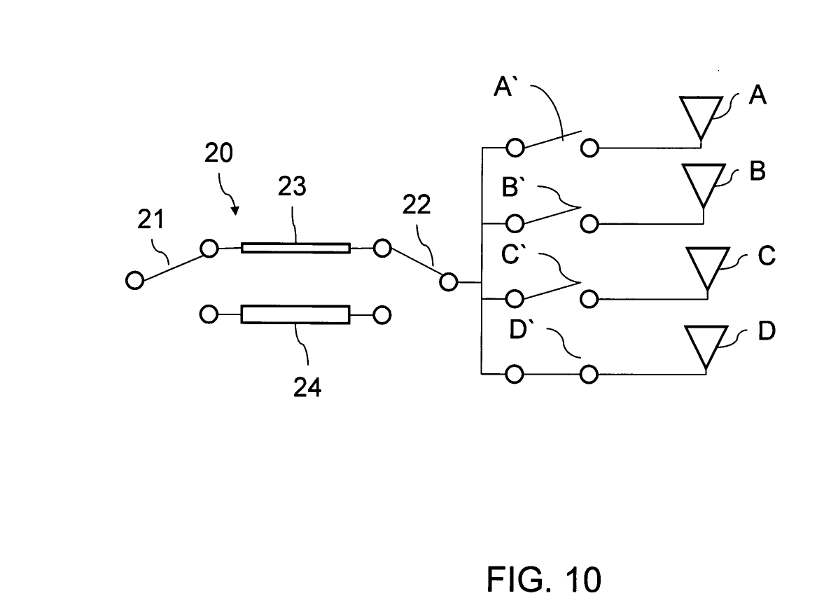

FIGS. 7 to 11 show schematic views of the switching circuit when different antenna units are turned on. The switching circuit includes four switching units A′, B′, C′, and D′, and a single-pole dual-throw switch 20. The single-pole dual-throw switch 20 consists of a first switch 21, a second switch 22, a high impedance transmission path 23, and a low impedance transmission path 24. As shown in FIG. 7, the switching unit is closed when the antenna unit A is turned on in the sector mode, while the switching units B′, C′, and D′ are open. Therefore, only the antenna unit A′ has an action, achieving the sector mode of the antenna unit A′.

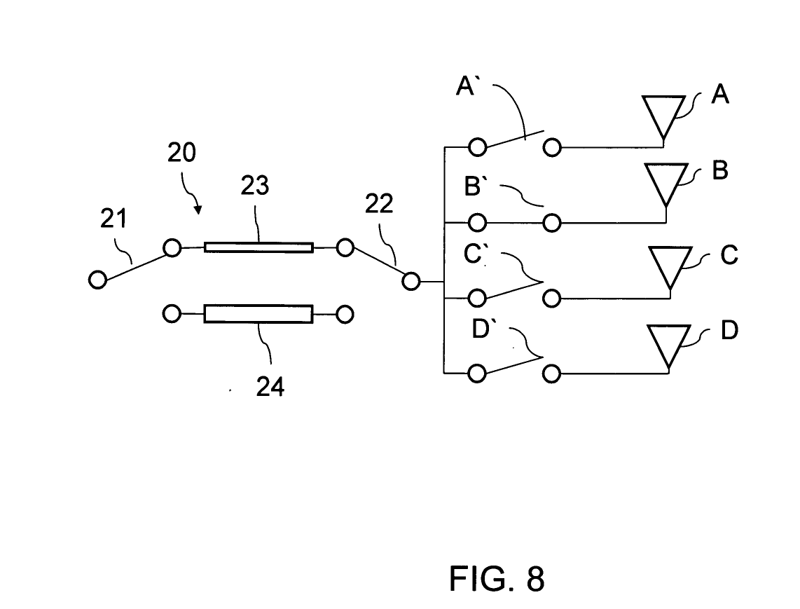

Likewise, FIGS. 8 to 10 respectively show the switching circuit for the sector modes in different directions when the antenna units B′, C′, and D′ are individually turned on.

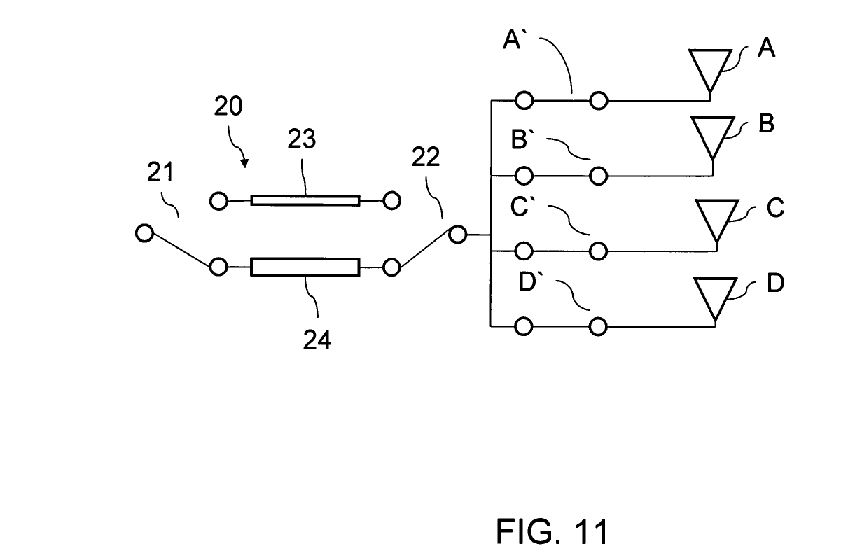

As shown in FIG. 11, the switching units A′, B′, C′, and D′ controlling the antenna units A, B, C, and D are turned on simultaneously to achieve the omni mode. However, the four simultaneously working antennas results in a low impedance of, for example, 12.5Ω because of the parallel connection of the four sets of antenna units, each of which has a high impedance of, for example, 50Ω. Therefore, the first switch 31 and the second switch 32 are a set of single-pole dual-throw combination, switching the transmission path from a high impedance transmission path 33 to a low impedance transmission path 34. This section has a length of one quarter the wavelength, forming a 25Ω quarter wavelength converter, changing the impedance from low to high and achieving the impedance matching.

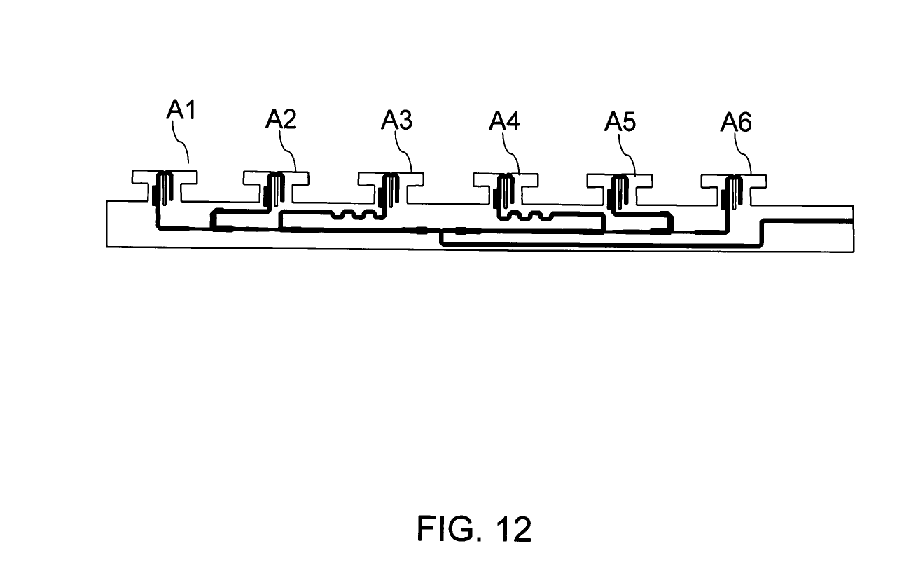

The circuit design of the disclosed antenna unit is illustrated in FIG. 12. Take the antenna unit A as an example, there are six sub-antenna units A1, A2, A3, A4, A5, and A6, disposed in a vertical array. The gain of the antenna is 14 dBi.

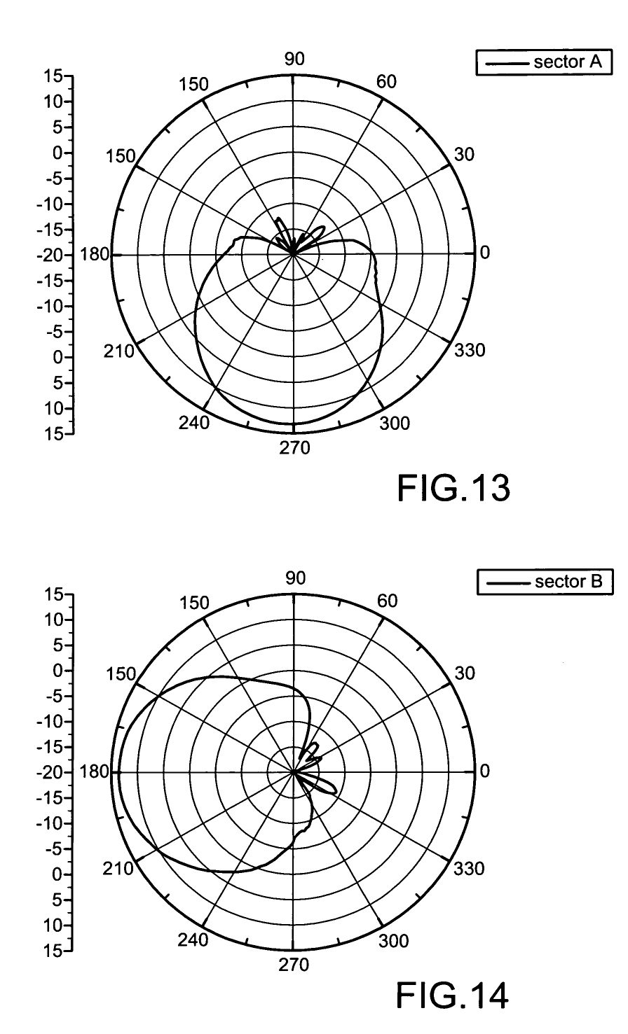

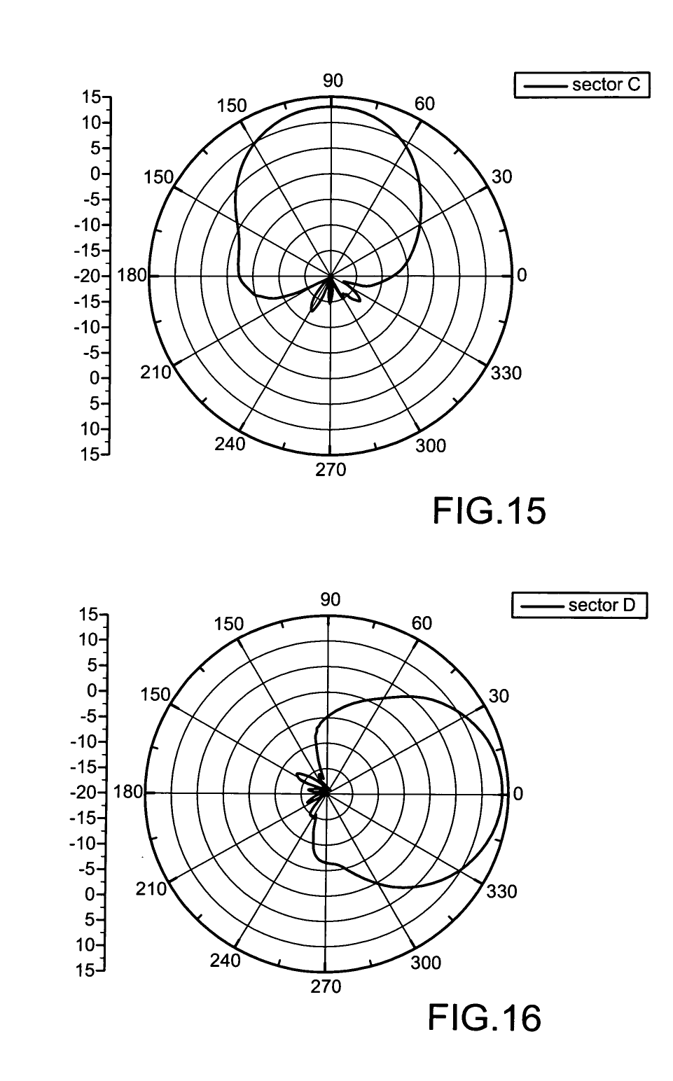

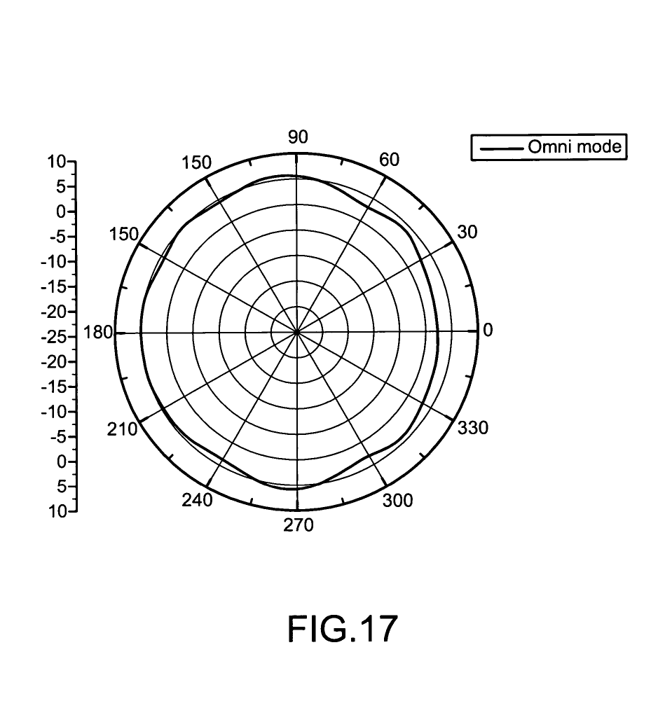

The radiation fields of the antenna units A, B, C, and D in the sector mode are measured in an anechoic chamber and the results correspond respectively to FIGS. 13, 14, 15, and 16. When all of the antenna units are turned on simultaneously, as in the omni mode, the measured radiation field is shown in FIG. 17.

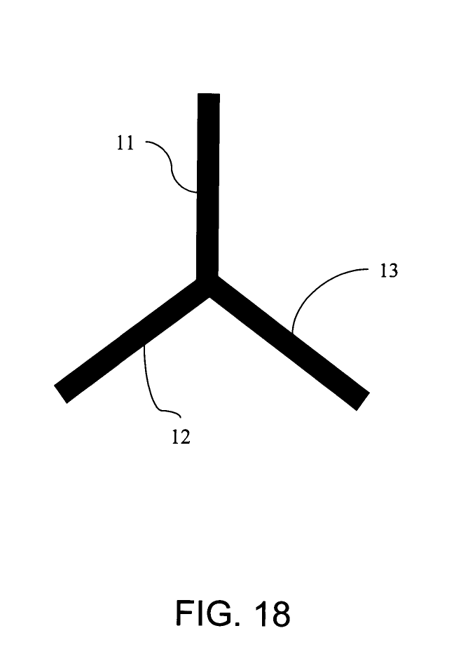

In this embodiment, the antenna is installed in the L region of a cross structure. Each unit covers a radiation angle of 90 degrees. In another embodiment shown in FIG. 18, the radiation direction dividing unit 10 is comprised of metal reflector plates 11, 12, 13. There are totally three antenna units, each of which covers a radiation angle of 120 degrees. As seen in the above two embodiments, the disclosed smart antenna can be designed to cover a desired range of radiation angles for the transmission and reception parts according to the location of the base station.

The disclosed smart antenna can adjust to achieve smart control according to the communication loads of different units.

Certain variations would be apparent to those skilled in the art, which variations are considered within the spirit and scope of the claimed invention.

1. A smart antenna system with switched beams selectively operating in an omni mode and a sector mode, comprising:
a set of radiation direction dividing unit, which consists of a plurality of metal reflector plates to divide space into a plurality of radiation directions;
a plurality of antenna units, each of which is correspondingly installed in one of the radiation directions; and
a switching circuit, which has a plurality of switches corresponding to the antenna units;
wherein the switching circuit transmits a radio frequency (RF) signal to one of the corresponding antenna units in the sector mode for the antenna unit to radiate the RF signal and to all of the antenna units in the omni mode for the antenna units to radiate the RF signal.

2. The smart antenna system of claim 1, wherein the radiation directions comprises four.

3. The smart antenna system of claim 1, wherein the radiation directions comprises three.

4. The smart antenna system of claim 1, wherein the antenna unit is an array of a plurality of sub-antenna units disposed in the vertical direction.

5. The smart antenna system of claim 1, wherein the switching circuit further contains a single-pole dual-throw switch to switch between the omni mode and the sector mode.

6. The smart antenna system of claim 5, wherein the single-pole dual-throw switch includes:
a first switch, which is coupled to the input terminal of the RF signal;
a second switch, which is selectively coupled to the switch;
a high impedance transmission path, which transmits the RF signal in the sector mode; and
a low impedance transmission path, which transmits the RF signal in the omni mode.
